(19) United States
(12) Patent Application Publication
(10) Pub. No.: US 2002/0146940 A1
(43) Pub. Date: Oct. 10, 2002

(54) Magnetically integrated jack

(76) Inventors: Robert Colantuono, Dover, PA (US); David Champlin, Bedford, PA (US); David Gutter, Felton, PA (US); Pat Hulbert, New Providence, PA (US); Ronald Locati, York, PA (US)

Correspondence Address: STEINBERG & RASKIN, P.C., 1140 AVENUE OF THE AMERICAS, 15th FLOOR, NEW YORK, NY, 10036-5803, US

(21) Appl. No.: 09/832,169

(22) Filed: Apr. 10, 2001

(51) Int. Cl. H01R 24/00

(52) U.S. Cl. 439/676

(57) ABSTRACT

An electrical connector assembly including a housing having front, rear, top, bottom and side parts which define first and second cavities, the first cavity structured and arranged to form part of a modular RJ-45 jack, the second cavity structured and arranged to receive a USB jack, the housing further including downward extending terminal pins electrically coupled to the modular jack, a rear cover attachable to the housing's rear part, a shield substantially surrounding the sides and top and rear parts of the housing and the rear cover, the rear cover and the housing having respective terminal pin engaging elements, the rear cover being movable to engage the housing, whereby the terminal pin engaging elements of the rear cover and of the housing move toward each other, capturing between them the terminal pins and maintaining these pins separate from each other.

### FIELD OF THE INVENTION

The present invention relates to modular electrical connector components mounted to printed circuit boards and more specifically to RJ-45 and USB modular jack connectors, integrated magnetics, LEDs and light pipes and efforts to structurally combine these components.

### BACKGROUND OF THE INVENTION

Personal computer manufacturers, such as Compaq, Dell, IBM, Sony and others utilize in their desktop, laptop and related computer products, RJ-45 and USB connectors in various combinations with integrated magnetics, LEDs and light pipes, all as individual devices which must be selected, incorporated into overall designs, purchased, maintained in inventory and handled in assembly. Not only does this traditional practice entail added material cost and time of handling and processing these separate components, but each component has its own housing and structural requirements which when assembled together consume precious real estate on the printed circuit (PC) board. Continued developments in computer design are demanding more features in less space, in addition to reduced cost if possible, which is a continuing problem in the design and manufacturing process.

As this field developed each new electronic device with its own housing was added as a separate element, with space and cost not the predominant concern. In due course certain efforts were made to combine LEDs with light pipes and to combine connectors with LEDs with or without their light pipes, and to further combine integrated magnetics. However, connector jacks, USBs, integrated magnetics, shielding and LEDs have such unique, characteristics and structures and sometimes conflicting functions, that efforts to combine them have been less than satisfactory. Some of the resulting devices have excessive and complex elements and high cost, examples being found in various prior art devices of manufacturers such as Amp, Full Rise Electronics, Foxlink and Foxxcon. The present invention has achieved an integration of USB and RJ-45 connectors with LEDs, light pipes and integrated magnetics into a single device whose central structure is a new single, simple, inexpensive and reliable housing.

### OBJECTIVES AND SUMMARY OF THE NEW INVENTION

A first objective of the new invention is to provide a unitary connector device which integrates all or subcombinations of the traditionally separate devices, which include RJ-45 and USB connectors, magnetics, LEDs and light pipes.

A further objective is to provide a novel internal housing in which and/or on which said individual components are mounted. In one preferred embodiment the USB will be positioned below the RJ-45 and integrated magnetics will be behind the USB. In another embodiment the internal housing will serve as the RJ-45 connector and will receive within it a standard USB connector.

A still further objective is to provide for such housing a rear cover which includes LEDs mounted thereon and light pipes formed within and as part of the body of the rear cover. In a preferred embodiment this rear cover is made of light transmitting plastic, with portions of the cover functioning as light pipes. A still further object is to achieve by such new integrated connector device reduced costs of manufacturing, including (a) reduction of cost of material, production and inventory of the multiplicity of elements; (b) elimination of duplication of housing walls for all the separate components; and (c) reduction of costs of designing clearance dimensions as traditionally required with assembly of multiple elements packaged into the smallest possible space.

Another object is to provide a housing and a rear cover combination which automatically positions, separates and secures the contact pins extending downward from the RJ-45 and/or the USB connector.

A still further object is to provide a new method and structure for placement and securing the magnetics component between laterally extending fingers on the housing and rear cover.

The above-described invention may take the form of a new housing for a connector assembly or a connector assembly including the new combination housing structure. One version of the new housing comprises:

(a) front, rear, top, bottom and side parts, said housing including at least one cavity structured and arranged to at least partially define an RJ-45 jack receptacle adapted to receive a set of electrical contacts for said at least one cavity and said set of electrical contacts to form an RJ-45 jack,

(b) downward extending terminal pins electrically connected to said electrical contacts,

(c) a rear cover attachable to said housing's rear part,

(d) a front set of terminal pin engaging elements extending rearwardly from said housing, and

(e) a rear set of terminal pin-engaging elements extending frontward from said rear cover, said rear cover being movable frontward to engage said housing, whereby said front and rear sets of terminal pin engaging elements move toward each other, capturing between them said downward extending terminal pins.

One version of new electrical connector comprises a housing assembly having spaced apart side walls, a first transverse wall extending between said side walls near the top thereof, a second traverse wall extending between said side walls situated below and spaced from said first transverse wall, said side walls and first transverse wall defining between them an upper recess, electrical contacts situated in said upper recess which together form an RJ-45 connector, said side walls and second transverse wall defining between them a lower recess into which a USB connector is receivable, said housing having front, rear and top parts, and downward extending terminal pins electrically coupled to said electrical contacts, a rear cover attachable to said housing's rear part, a front set of terminal pin engaging elements extending rearward from said housing and a rear set of terminal pin engaging elements extending frontward from said rear cover, said rear cover being movable frontward to engage said housing, whereby said front and rear sets of terminal pin engaging elements move towards each other, capturing between them said downward extending terminal pins.

For all these embodiments it is an object to provide a simple, inexpensive and reliable integrated modular connector.

### BRIEF DESCRIPTION OF THE DRAWINGS

A more complete appreciation of the present invention and many of the attendant advantages thereof will be readily understood by reference to the following detailed description when considered in connection with the accompanying drawings in which:

FIG. 1 is an exploded top front perspective view of a first embodiment of a new integrated connecter according to the present invention;

FIG. 2 is a top front perspective view of the housing of the new integrated connector according to the invention of FIG. 1; FIG. 3 is a top rear perspective view of the housing according to the invention of FIG. 1;

FIG. 4 is a top rear perspective view of the shield in accordance with the invention of FIG. 1;

FIG. 5 is a top front perspective view of the rear cover of the invention of FIG. 1;

FIG. 5A is a fragmentary top plan view of the contact-engaging fingers of the rear cover and the housing shelf respectively;

FIG. 5B is a fragmentary top plan view showing upper and lower contact-engaging fingers overlapped and engaging contact wires;

FIG. 5C is a fragmentary perspective view of the engaged fingers of FIG. 5B, drawn with an exaggerated spacing between the upper and lower fingers to enhance clarity;

FIG. 6 is a top rear perspective view of the rear cover of the invention of FIG. 1;

FIG. 7 is a front elevation view of the embodiment of FIG. 1 shown in assembled state with the RJ-45, USB, LED and shield installed in accordance with the invention;

FIG. 8 is a bottom plan view of the embodiment of FIG. 7;

FIG. 9 is a left side elevation view of the embodiment of FIG. 7;

FIG. 10 is a top plan view of the embodiment of Fig.7;

FIG. 11 is a sectional view taken along line 11-11 in FIG. 10;

FIG. 12 is a fragmentary top plan view of a PC board showing a hole pattern into which the integrated connector of FIGS. 7-11 is installed;

FIG. 13 is a top rear perspective view of the housing for a second embodiment of an integrated connector assembly in accordance with the present invention;

FIG. 14 is a top rear perspective view of the rear cover for the housing of FIG. 13 in accordance with this invention;

FIG. 15 is a front perspective view of the rear cover of FIG. 14;

FIG. 16 is a top front perspective view of the integrated connector assembly showing the housing and the rear cover of FIGS. 13-15 in assembled state in accordance with this invention; and

FIG. 17 is a top rear perspective view of the integrated connector assembly of FIG. 16.

### DETAILED DESCRIPTION OF THE PREFERRED EMBODIMENTS

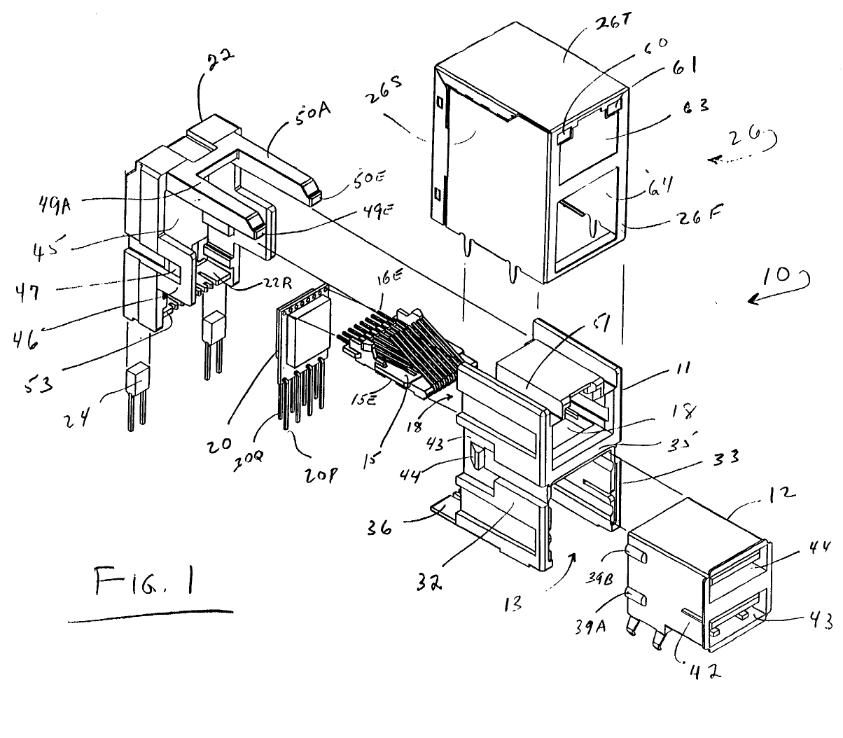

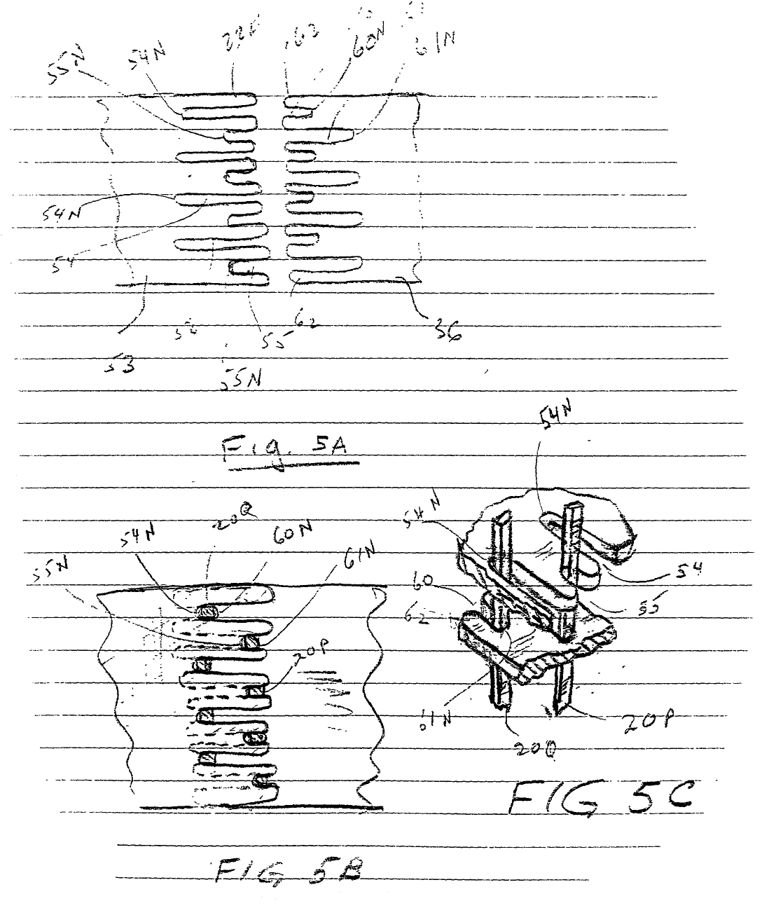

A first embodiment 10 of the new integrated connector assembly of the present invention is shown in the exploded view of FIG. 1, comprising the components: housing 11, USB jack 12 insertable into a lower front recess 13 in housing 11, contact holder 15 and contacts 16 insertable into an upper rear recess 18 in said housing forming an RJ-45 connector, magnetics 20 situated at the rear of and electrically coupled to said contacts 16, rear cover 22, and shield 26 generally encasing the above-described assembly. LEDs 24, also seen in FIG. 6, are mounted to rear cover 22, and light pipes 28 are formed within said cover as described in further detail below.

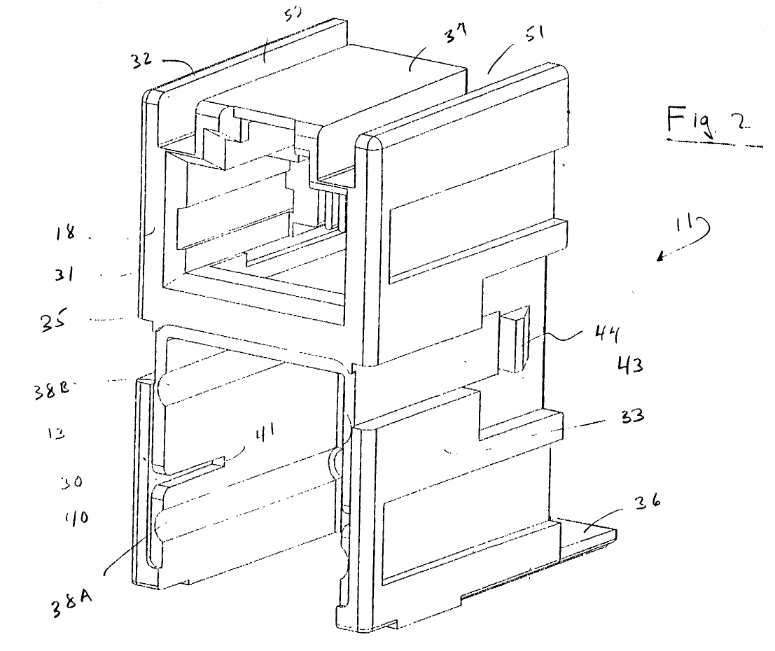

The housing 11 as seen in FIGS. 2 and 3 has lower part 30 defining therein recess 13 to receive a standard USB and upper part 31 defining therein recess 18 for receiving and retaining contact holder 15. This housing 11 is constructed of opposite side walls, namely right side wall 32 (the housing's own right side as seen in FIGS. 1 and 2), and left side wall 33, rear wall 34, front divider bar 35, bottom rear shelf or extension 36 and roof 37.

Inside lower recess 13 on each side wall are pairs of guide grooves or tracks 38A, 38B to receive mating ribs 39A, 39B on the USB (see FIG. 1) when inserted in this recess. Between intermediate grooves 38A, 38B on each side wall is another groove 40 which terminates in end 41. Groove 40 receives rib 42 on the outside wall of the USB (see FIG. 1), and end 41 serves as a stop against which rib 42 abuts when the USB is properly positioned in recess 13. The USB has its own standard recesses 43, 44 which are accessible in normal use of this device. This USB is typically a one or two high configuration or combination power USB.

As seen in FIGS. 1, 5 and 6 and as will be described more fully later, the housing 11 receives rear cover 22, which includes back 45, female latch tab 46 on the right side (with a similar latch tab on the opposite side), said latch tab including an aperture 47 therein with a latch edge 48. When the rear cover is placed onto the rear of housing 11, latch tab 46 of the rear cover slides into groove 43 of the housing, and latch edge 48 (FIG. 6) engages latch 44 (FIGS. 1 and 3) in an aligned and tight but releaseable coupling.

Rear cover 22 comprises two light pipes, represented by dotted lines 49, 50 which extend up the back 45 of cover 22, then forwardly as legs 49A and 50A which legs slide into elongated tracks 51, 52 respectively at the top of housing 22 (See FIGS. 1 and 2). Each light pipe is optically coupled to at least one LED, as will be described later, which serves as an indicator of the condition of a selected circuit. Each light pipe has a front light exit end 49E, 50E (see Figs, 1, 5, 6 and 9) which is visible and when illuminated provides visual indication of the circuit condition.

Returning now to the housing 22, FIG. 1 shows how contact holder 15 is directed into upper recess 18. FIG. 3 shows recess 18, and FIG. 11 shows contact holder 15 in recess 18. This contact holder is guided and positioned by its edges 15E which slide into grooves 18E (see FIG. 3). FIG. 11 further illustrates how contacts 16 are situated with their contact surfaces 16C in recess 18 which is adapted to receive a mating contact plug.

As seen in FIGS. 1 and 11, each of contacts 16 has a terminal end 16E electrically coupled to integrated magnetics device 20 and thence to a contact pin such as pin 20P which extends into a mating contact on the PC board. Where the integrated magnetics device is omitted, terminal end 16 may extend downwardly and serve as the contact pin.

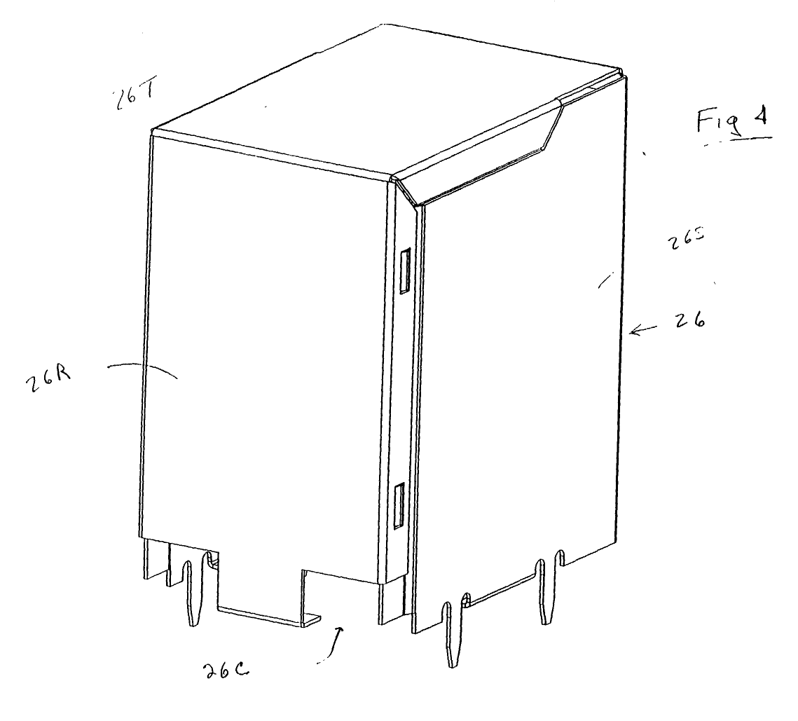

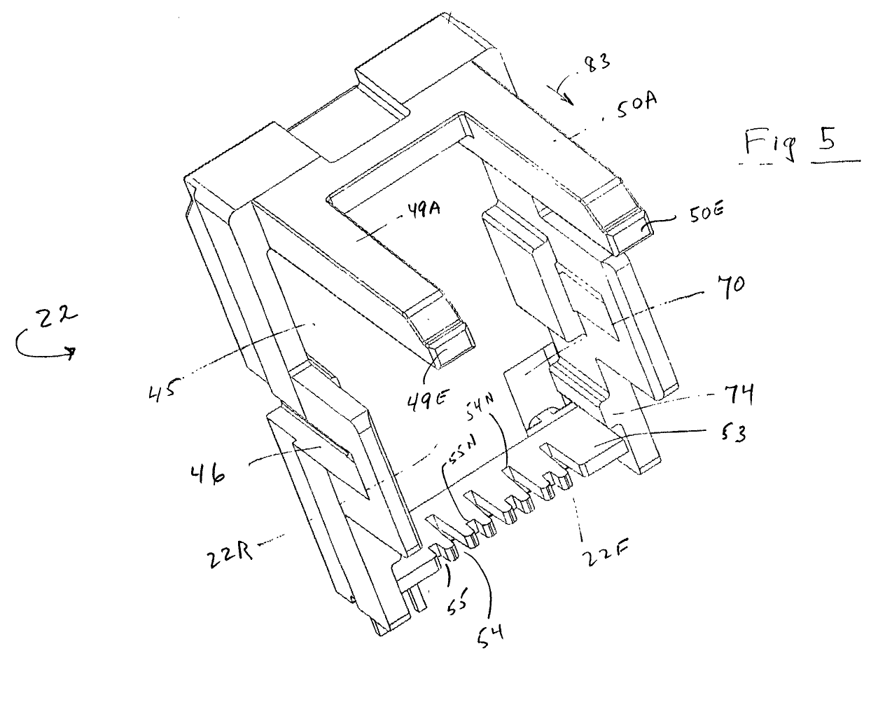

The rear cover 22 has a recess area 22R to accommodate the integrated magnetics device 20 and a shelf 53 with deep and shallow slots 54, 55 respectively (and best seen in FIG. 5) to receive and maintain separate the contact pins 20P from the integrated magnetic device 20. These slots cooperate with matching shallow and deep slots 60, 61 respectively in rear shelf 36 of the housing, as explained later.

As seen in FIGS. 1, 5 and 6 LEDs 24 are situated on the rear of rear cover 22. Above each LED is a vertical portion 49V, 50V respectively of a light pipe 49, 50 optically coupled to a forwardly extending horizontal portion 49A, 50A at the top of the rear cover 22.

As seen in FIGS. 1, 2, 3, and 5A-5C the housing includes rear shelf 36 with shallow and deep slots 60, 61 respectively. When rear cover 22 is assembled onto the rear of the housing 11, slots 54, 55 in this rear cover are aligned with slots 60, 61 in housing shelf 36. Each slot has a neck or end portion 54N, 55N, 60N and 61N respectively. More specifically, shelf 36 has rearward extending fingers 62 which define between them said shallow slots 60 and deep slots 61. Rear cover 22 has forward extending fingers 22F which define between them deep slots 54 and shallow slots 55. Before the rear cover is installed onto housing 11 the integrated magnetics 20 is mounted adjacent shelf 36 with pins 20P, 20Q of device 20 extending downward. Four pins 20P become situated in the necks 61N of the deep slots 61, and four other pins in the necks 60N of the shallow slots 60. These pins become locked at these neck areas of these slots, as follows.

When the rear cover is installed on the housing, its rear shelf 53 overlies shelf 36 of the housing (see FIGS. 5B, 5C and 11) so that each deep slot 54 of the shelf 53 overlies a shallow slot 60 of the housing, with the necks 54N and 60N of these overlying slots opposite and approaching each other, and with a pin extending downward through said slots. Said pin becomes captured between the converging neck areas, also called a pinch point, which thus positions, separates and locks the pin in such position. These pinch points lock all the pins 20P simultaneously and secure the integrated magnetics device quickly, easily and automatically without further separate assembly steps. Also, this arrangement allows lateral placement of the integrated magnetics instead of moving it vertically downward as traditionally required to feed or thread its contact pins through guide holes. FIGS. 5C and 11, for clarity, show the overlying shelves 53 and 36 vertically spaced; however, in practice they are close together to create the pinch point.

Mounting of the LED 24 is seen in FIGS. 5 and 6 where rear cover 45 has a recess part 69 which extends through the rear cover wall as a window 70. Below this window are locking tabs 71, 72 for engaging and restraining the downward legs 73 of the LED. Inward of window 70 is a rail 74 whose end 75 serves as a positioning stop when the LED is situated in window 70.

Transmission of light from the LEDs 24 to indicator panels 49E, 50E of the light pipes (see FIGS. 5 and 6) is achieved by another novel structural feature. These light pipes are not separate plastic or glass elements positioned in or on the rear cover; they are light transmission portions of the cover itself which in this case is made of clear plastic such as polycarbonate. The rear cover is configured to establish two substantially separate internal light paths while the rear cover remains a single contiguous plastic component. These light paths have been indicated by the dotted lines 49 and 50 which extend up two sides of back part 45 of the rear cover 22. As seen, these dotted lines make a 90° turn and then extend forwardly as legs 49A and 50A, both terminating as illuminated viewing surfaces 49E and 50E.

As seen in FIG. 6 light travels from LED 24 vertically upward through the light pipe (shown by dotted line 50) situated within the back wall 45 of the rear cover 22, and thence through the horizontal leg 50A of the light pipe. As seen this molded-in light pipe is bent 90° at area 82 via a flat or convex panel, and thence into horizontal leg 50. As seen in FIG. 5 leg 50 tapers in the forward direction indicated by arrow 83 to enhance the intensity of the light seen at viewing surface 50E.

As seen in FIGS. 5 and 6 there is provision for two LEDS, one on each side of the rear cover, leading to horizontal light pipe legs 49 and 50 respectively. To minimize bleeding or crossover of light from one to the other of this pair of molded-in light pipe legs there are provided windows 90 separated by bridge rails 91 seen in FIG. 6. As an alternative to windows 90 which extend completely through the rear cover thickness, the window area may instead be thinned creating depressions in the rear cover surface to reduce the possibility of light leakage between the spaced light pipe legs 49 and 50. Thus, light from the two LEDs is inclined to follow two separate light paths. After these light paths make the 90° turn they remain substantially separated because of the separate legs 49A, 50A. It should be noted that the integrated connector device disclosed herein could alternatively be designed to omit the LEDs, and instead to straddle a surface mounted LED on a PC board.

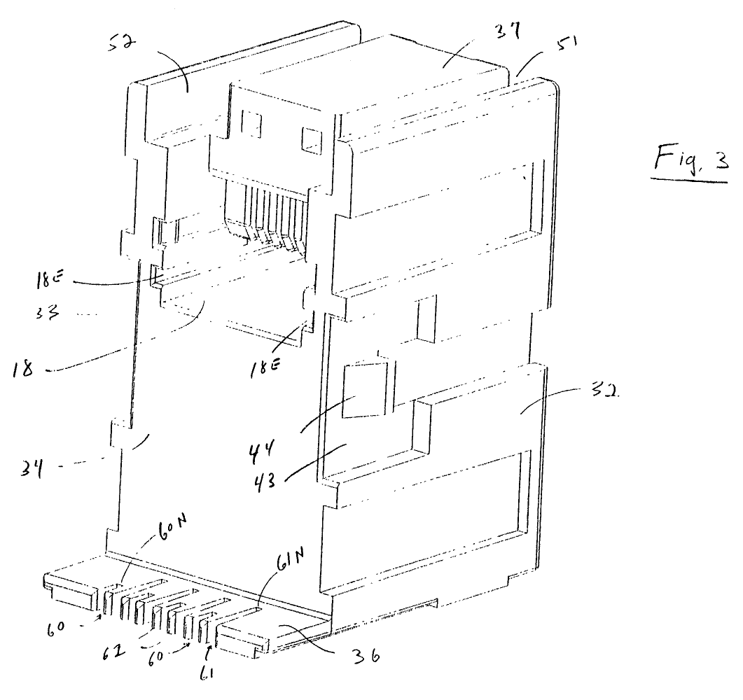

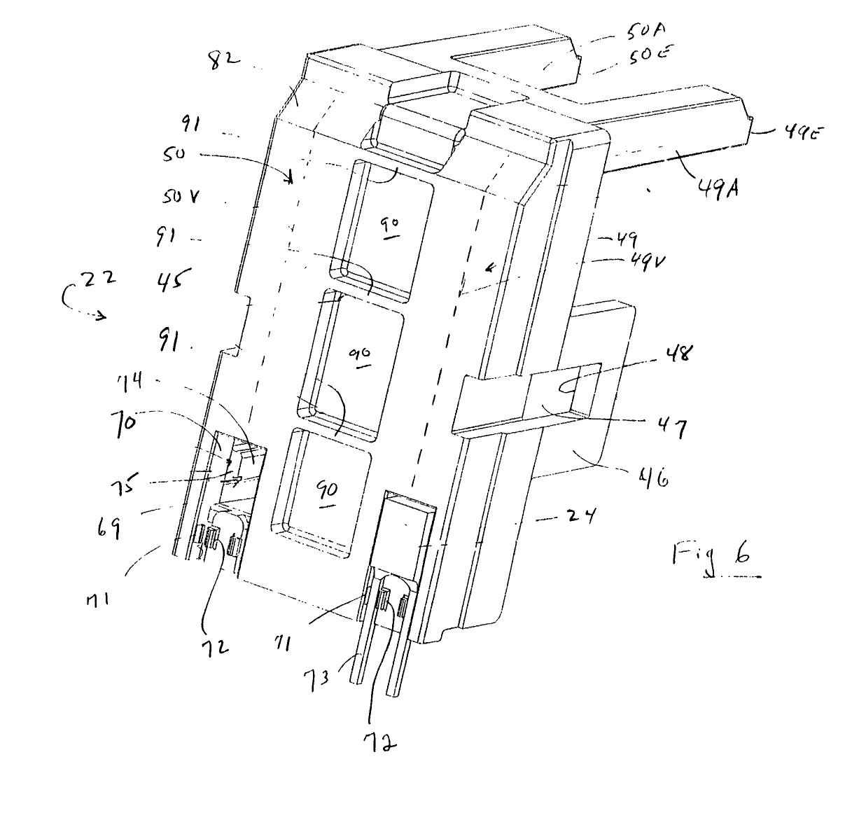

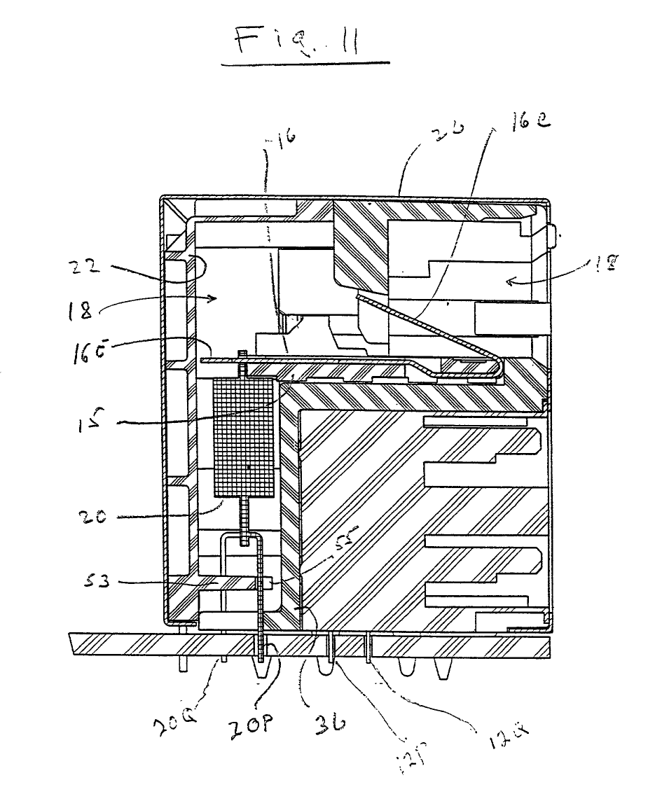

This whole assembly as described herein is encased in shield 26 as seen in FIGS. 1, 4, 7-9, and 11. This shield has top 26T, opposite sides 26S, rear 26R, and front 26F with windows 60 and 61 through which the visible end of the light pips are seen, and window 63 for access to the plug recess 18, and window 64 for access to the USB. As seen in FIGS. 1 and 4 the shield 26 has in its rear wall 26R cutouts 26C which overlie the LEDs and satisfy the DWV requirements.

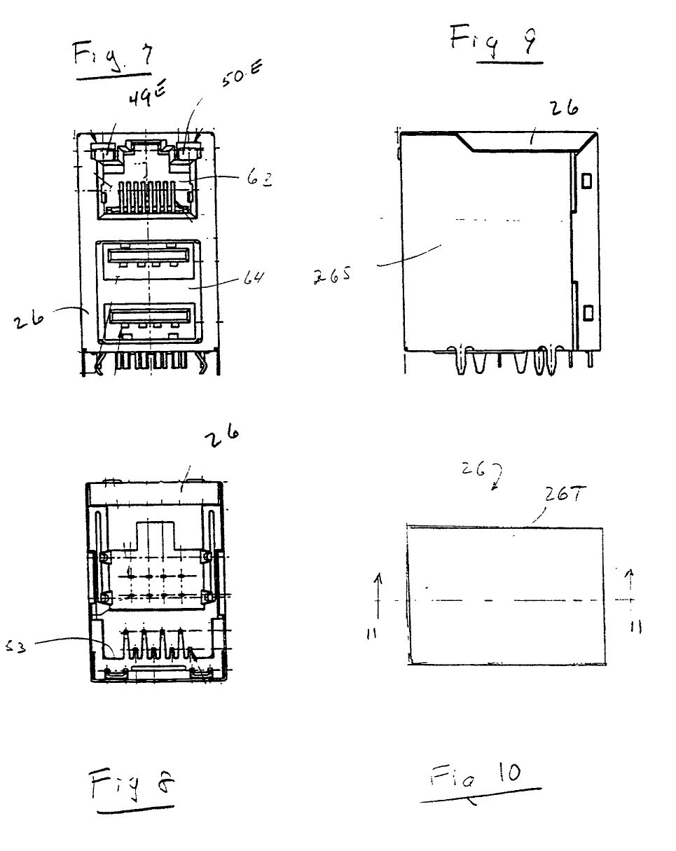

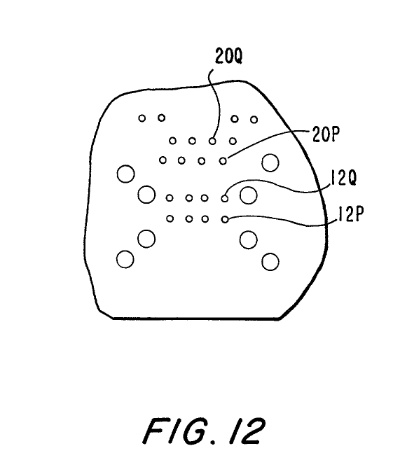

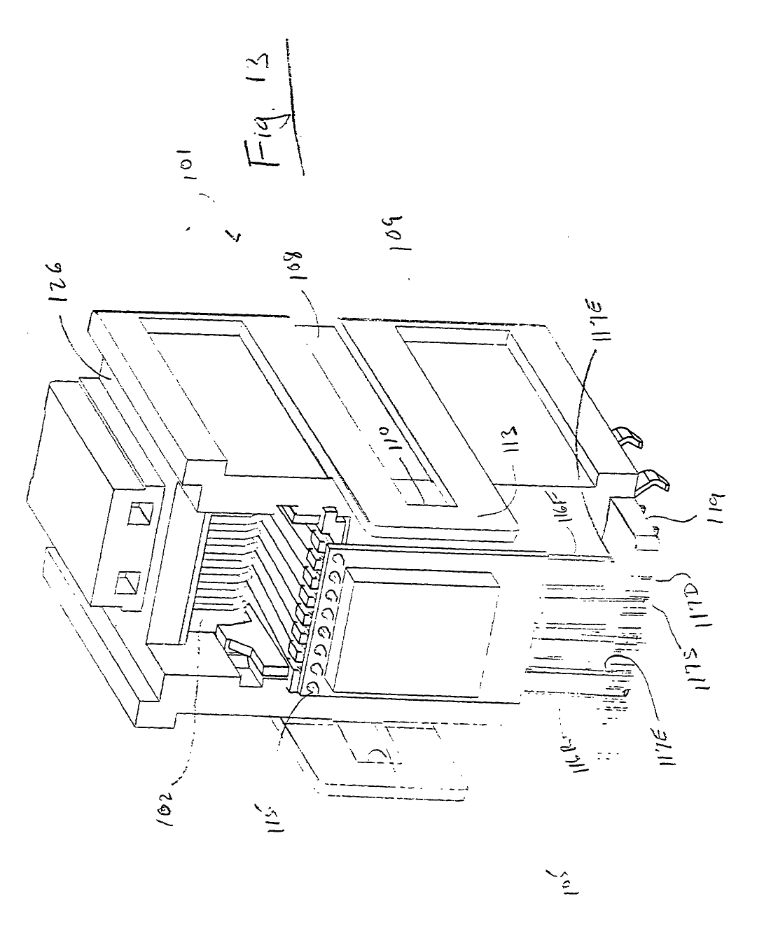

FIG. 11 shows downward extending contact pins 12P, 12Q from USB 12, and downward extending pins 20P, 20Q from the integrated magnetics 20. FIG. 8 shows a plan view of these pins, and FIG. 12 shows a hole layout in the PC board to receive these pins. FIG. 8 is inverted from FIG. 12 because FIG. 8 is an upside bottom plan view of the new integrated connector assembly.

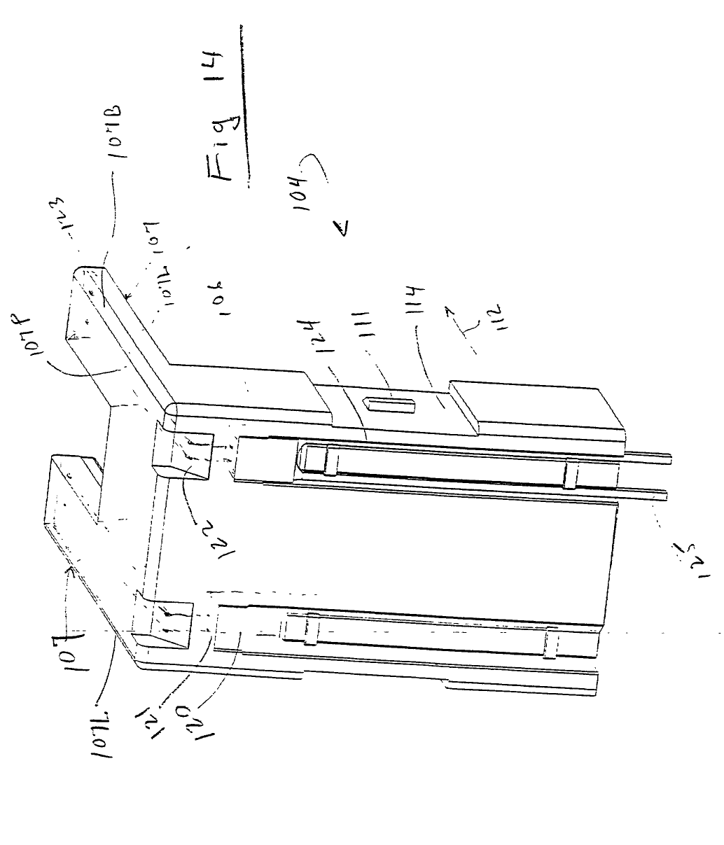

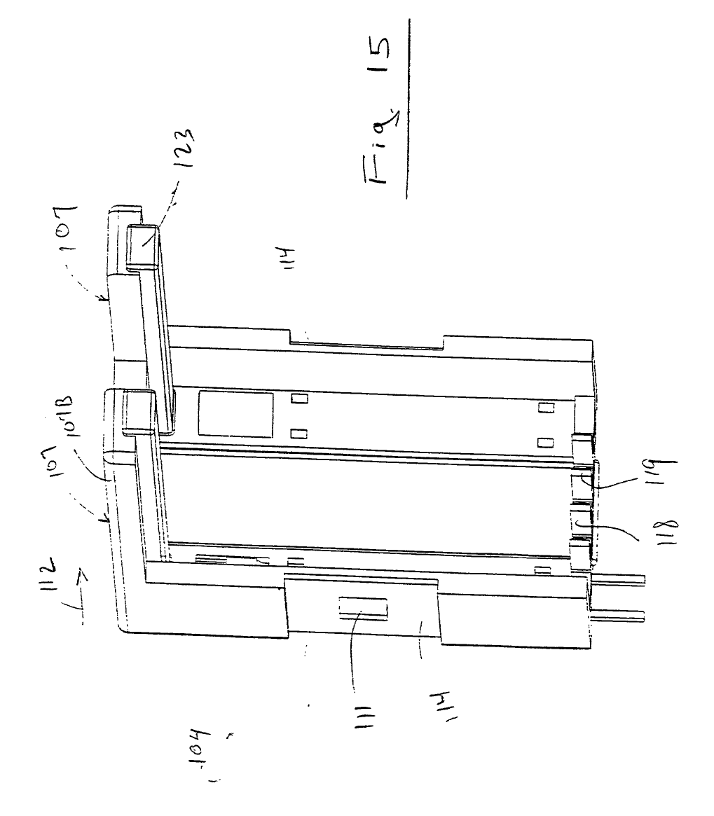

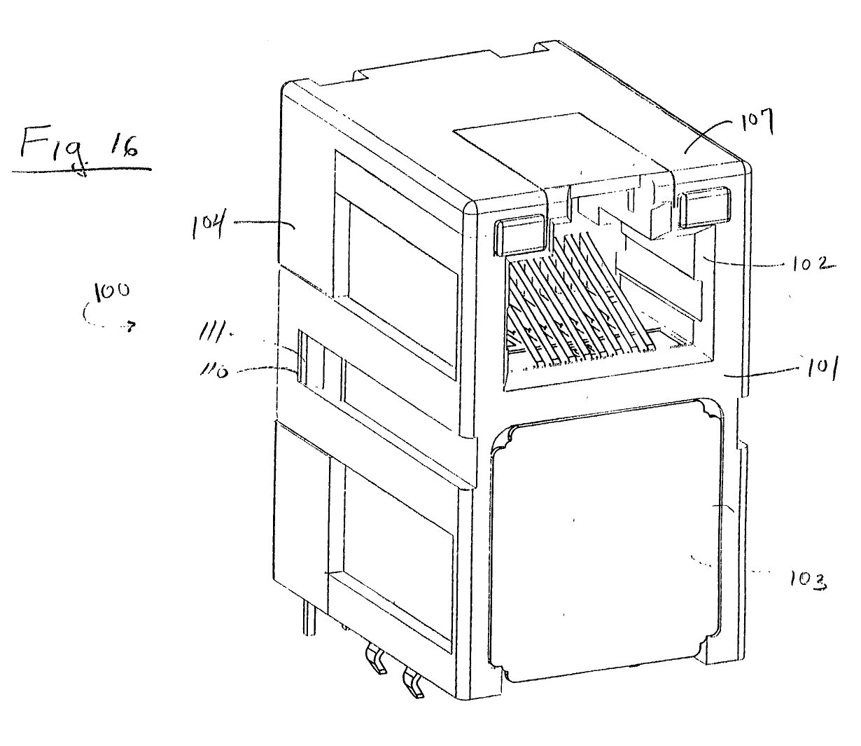

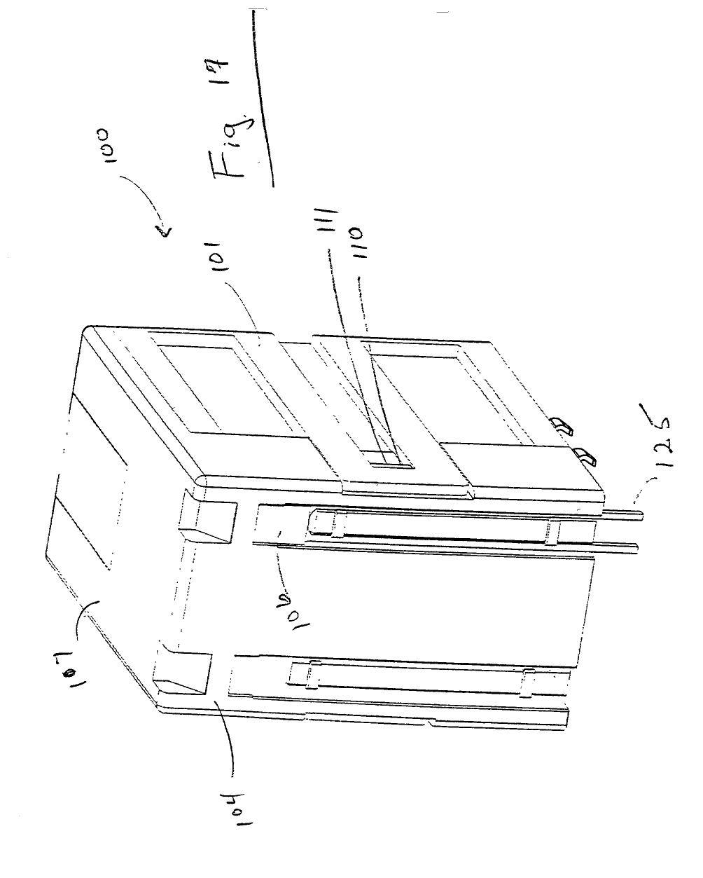

FIGS. 13-17 illustrate a second embodiment 100 of the present invention of an integrated connector assembly which is similar in part to the above-described first embodiment. Major components ofthis second embodiment are the housing 101 including an upper level connector 102 which is shown as an RJ-45 connector and a lower level connector 103 which is not shown but is an USB connector. FIG. 13 shows the housing 101 assembly, FIGS. 14 and 15 show the rear cover 104, and FIGS. 16 and 17 show the housing and rear cover in assembled state. FIG. 13 shows the further components namely integrated magnetics 105 electrically coupled to the RJ-45 connector 102, FIGS. 14 and 17 show an LED 106, and FIGS. 14-17 show various portions or views of a light pipe 107.

FIG. 13 shows another embodiment of this invention where the housing 101 has upper and lower parts for the RJ-45 and USB connectors respectively. At the right side 108 is latch element 109 with its edge 110 for releaseable coupling to latch tab 111 on the rear cover 104. When the rear cover 104 (seen in FIGS. 14 and 15) is moved forward in the direction of arrow 112 the U-shaped portion 113 of latch tab 109 overlies recess area 114 of rear cover 104 until edge 110 of latch element 109 engages and becomes coupled to latch tab 111. FIGS. 16 and 17 show the rear cover 104 fully engaged to the housing 101.

As seen in FIG. 13, at the rear of housing 101 is mounted integrated magnetics 105 which is electrically connected to the RJ-45 connector by contacts 115. Extending downward from integrated magnetics 105 are contact pins in two rows, namely rear pins 116R and front pins 116F. These pins lie respectively in shallow and deep grooves 117S and 117D formed between fingers 118 extending rearwardly from shelf 119 at the bottom of housing 101. Each of these grooves has an end edge 117E against which a contact pin is pressed and captured when the rear cover is attached to housing 101.

To achieve this capturing of contact pins 116R, 116F rear cover 104 has forward extending pin-engaging elements or fingers 118 which enter grooves 117S, 117D until the ends 119 of the fingers 118 engage and press the contact pins against the respective end edges 117E of the deep and shallow grooves. With this arrangement attachment of the rear cover 104 to the housing automatically captures the contact pins and maintains them separate from each other and stabilizes them near the bottom of the housing from which they are extended into the PC board.

This embodiment also has two light pipes 107 formed by light paths 107P through the rear cover 104. Each LED 106 is situated in arecess 120 with a light entry surface 121 adjacent the light emitting surface of the LED. The light, as schematically represented by dashed lines 107D, then travels upward to the inclined surface 122, is then reflected forward along light path 107 to light exit surface 123. The legs 107L projecting forward from the rear cover are spaced apart which helps maintain the two light paths separate from each other. Beveled edges 107B help concentrate the light in the light path. Below each LED extend connector wires 124 having terminal ends 125.

In housing 101 as seen in FIG. 13 are tracks 126 which receive light pipe projections when the rear cover is moved forward for attachment to the housing. FIGS. 16 and 17 show the housing and rear cover joined into the combination connector assembly.

The structural feature of this invention of the pin-engaging elements extending from the rear cover and from the housing is applicable to combination connectors which may comprise many different subcombinations. For example, the connector may include an RJ-45 connector or an USB connector or both, and may further include one or more LEDs for the respective connectors, and may further include one or more light pipes, and/or may include integrated magnetics. Also, the pin engaging elements may take a variety of forms, and the light pipes may be portions of the light transmitting rear cover as shown or may be independent elements. Also, as discussed above, the new housing may be constructed to serve as the connector or may receive an existing modular USB other connector jack or both.

Obviously, numerous modifications and variations of the present invention are possible in light of the above teachings. It is therefore to be understood that within the scope of the claims appended hereto, the invention may be practiced otherwise than as specifically disclosed herein.

1. A housing for a connector assembly, said housing comprising:
(a) front, rear, top, bottom and side parts, said housing including at least one cavity structured and arranged to at least partially define an RJ-45 jack receptacle adapted to receive a set of electrical contacts for said at least one cavity and said set of electrical contacts to form an RJ-45 jack,
(b) downward extending terminal pins electrically connected to said electrical contacts,
(c) a rear cover attachable to said housing's rear part,
(d) a front set of terminal pin engaging elements extending rearwardly from said housing, and
(e) a rear set of terminal pin-engaging elements extending frontward from said rear cover, said rear cover being movable frontward to engage said housing, whereby said front and rear sets of terminal pin engaging elements move toward each other, capturing between them said downward extending terminal pins.

2. A housing according to claim 1, said housing including a pair of cavities, one of said cavities being the said cavity structured and arranged to at least partially define an RJ-45 jack receptacle and the other of said pair of cavities structured and arranged to receive a USB jack.

3. A housing according to claim 1 further comprising a contact holder on which said electrical contacts are mounted, said contact holder being inserted in said at least one cavity.

4. A housing according to claim 1 wherein the RJ-45 jack is independent of and attachable to said housing.

5. A housing according to claim 1, further comprising at least one LED mounted on said rear cover, and at least one light pipe formed in said rear cover, said light pipe having an inlet end adjacent said LED and an outlet end.

6. A housing according to claim 5, wherein said rear cover comprises light-transmitting plastic, and at least a portion of said rear cover comprises said light pipe.

7. A housing according to claim 5 wherein rear cover comprises a plurality of areas functioning as generally separate light pipes.

8. A housing according to claim 6, wherein said rear cover comprises an upward extending back wall and at least one forwardly extending projection, and said light pipe is situated partially in said upward extending back wall and partially in said forwardly extending projection.

9. A housing according to claim 6, wherein said rear cover defines therein a pair of spaced apart light pipes, and said housing further comprises a pair of LEDs mounted on said rear cover, each LED being optically coupled to one of said light pipes.

10. A housing according to claim 6 wherein said rear cover has opposite side parts and a central part between and thinner than said opposite side parts, said central part able to transmit less light than said side parts such that said side parts function as generally separate light pipes, and said housing further comprises a pair of LEDs mounted on said rear cover, each LED being optically coupled to one of said light pipes.

11. A housing according to claim 6 wherein said rear cover has opposite side parts and a central part between said opposite side parts, said central part defining therein an aperture extending through said cover such that light transmitted through said side parts substantially cannot leak across said aperture between said side parts, said side parts thus functioning as generally separate light pipes, said housing further comprising a pair of LEDs mounted on said rear cover, each LED being optically coupled to one of said light pipes.

12. A housing according to claim 1 wherein said rear cover comprises light-transmitting plastic, and at least a portion of said light-transmitting plastic comprises a light pipe.

13. A housing according to claim 12 and mountable to a PC board and operable with a surface-mounted LED, wherein said light pipe has a light entry surface facing downward and situated generally adjacent said LED.

14. A housing according to claim 1, wherein said housing's rear part has a bottom portion, and said housing further comprises a first shelf extending rearward from said bottom portion, and said terminal pin engaging elements extend rearward from said shelf.

15. A housing according to claim 14, wherein said rear cover further comprises a second shelf extending frontward and includes said terminal pin engaging elements.

16. A housing according to claim 15, wherein said second shelf at least partially overlies said first shelf in a different plane from that of said first shelf when said cover is engaged to said housing.

17. A housing according to claim 15 wherein said downward extending terminal pins are arranged in front and rear rows, one row displaced forward of the other, and wherein said terminal pin engaging elements in each of said shelves correspond to said front and rear displaced rows of terminal pins.

18. A housing according to claim 15 wherein said first and second shelves lie generally in the same plane.

19. A housing according to claim 17 wherein said terminal pins are numbered alternatively with “odd” and “even” numbers, and said odd-numbered pins are in one of said front and rear rows and said even- numbered pins are in the other of said front and rear rows.

20. A housing according to claim 1 further comprising integrated magnetics situated between and electrically coupled to said RJ-45 jack and said downward extending terminal pins.

21. A housing according to claim 1 further comprising a shield substantially surrounding said sides and said top and rear parts of said housing and said rear cover.

22. An electrical connector comprising a housing assembly having spaced apart side walls, a first transverse wall extending between said side walls near the top thereof, a second traverse wall extending between said side walls situated below and spaced from said first transverse wall, said side walls and first transverse wall defining between them an upper recess, electrical contacts situated in said upper recess which together form an RJ-45 connector, said side walls and second transverse wall defining between them a lower recess into which a USB connector is receivable, said housing having front, rear and top parts, and downward extending terminal pins electrically coupled to said electrical contacts, a rear cover attachable to said housing's rear part, a front set of terminal pin engaging elements extending rearward from said housing and a rear set of terminal pin engaging elements extending frontward from said rear cover, said rear cover being movable frontward to engage said housing, whereby said front and rear sets of terminal pin engaging elements move towards each other, capturing between them said downward extending terminal pins.

23. An electrical connector according to claim 22 further comprising a shield substantially surrounding said sides and said top and rear parts of said housing and said rear cover.

24. A connector according to claim 23 further comprising integrated magnetics electrically coupled between said RJ-45 connector and said downward extending terminal pins.

25. A connector according to claim 22 wherein said rear cover comprises light-transmitting plastic, at least a portion of which functions as a light pipe.

26. A connector according to claim 25 wherein said rear cover comprises an upward extending back wall and at least one forwardly extending projection, and said light pipe is situated partially in said upward extending back wall and partially in said forwardly extending projection.

27. A connector according to claim 25 wherein said rear cover defines therein a pair of spaced apart light pipes, and said housing further comprises a pair of LEDs mounted on said rear cover, each of said LEDs being optically coupled to one of said light pipes.

28. A connector according to claim 22 wherein said housing's rear part has a bottom portion, and said housing further comprises a first shelf extending rearward from said bottom portion, and said terminal pin engaging elements extend rearward from said shelf.

29. A connector according to claim 28 wherein said rear cover further comprises a second shelf extending frontward and includes said terminal pin engaging elements.

30. A connector according to claim 29 wherein said second shelf at least partially overlies said first shelf in a different plan from that of said first shelf when said cover is engaged to said housing.

31. A connector according to claim 15 wherein said downward extending terminal pins are arranged in front and rear rows, one row displaced forward of the other, and wherein said terminal pin engaging elements in each of said shelves correspond to said front and rear displaced rows of terminal pins.

32. A connector according to claim 22 wherein each of said housing side walls has an outward surface and further comprises a male latch element on said outward surface, and said rear cover has opposite sides and a flexible and resilient female latch element on each of said opposite sides, said female latch elements being releaseably coupled to said male latch elements when said rear cover is moved forward to become engaged to said housing.

33. A connector according to claim 24 further comprising a USB jack inserted into said lower recess of said housing.

34. A connector according to claim 22 wherein said housing assembly further comprises a contact holder on which said electrical contacts are mounted, said contact holder and contacts mounted thereon being inserted and mounted in said upper recess.

35. A connector according to claim 25 wherein said rear cover defines therein a pair of spaced apart light pipes, and said housing further comprises a pair of LEDs mounted on said rear cover, each LED being optically coupled to one of said light pipes.

36. A connector according to claim 22 wherein each of said sets of terminal pin engaging elements comprises a set of spaced apart fingers with slots between each two adjacent fingers, each of said slots having an end formed as an end edge, whereby each end edge of each of said sets cooperates with one end edge of said other set to capture between them one of said downward extending terminal pins.

37. A connector according to claim 22 wherein said rear cover has opposite side parts and a central part between said opposite side parts, said central part defining therein an aperture extending through said cover such that light transmitted through said side parts substantially cannot leak across said aperture between said side parts, said side parts thus functioning as generally separate light pipes, said housing further comprising a pair of LEDs mounted on said rear cover, each LED being optically coupled to one of said light pipes.

38. A connector according to claim 22 further comprising a USB jack inserted into said second cavity of said housing.
